(19) United States
(12) Patent Application Publication
(10) Pub. No.: US 2019/0130215 A1
(43) Pub. Date: May 2, 2019

(54) TRAINING METHOD AND DETECTION METHOD FOR OBJECT RECOGNITION

(71) Applicant: OSRAM GmbH, Munich (DE)

(72) Inventors: Herbert Kaestle, Traunstein (DE); Meltem Demirkus Brandlmaier, Munich (DE); Michael Eschey, Wehringen (DE); Fabio Galasso, Garching (DE); Ling Wang, Eching (DE)

(21) Appl. No.: 16/094,503

(22) PCT Filed: Mar. 23, 2017
(86) PCT No.: PCT/EP2017/056933

§ 371 Date: Oct. 18, 2018

(30) Foreign Application Priority Data
Apr. 21, 2016 (DE) 10 2016 206 817.2

(51) Int. Cl. G06K 9/62; G06K 9/00

(52) U.S. Cl. CPC G06K 9/6256; G06K 9/00771

(57) ABSTRACT

A training method for object recognition, the training method comprising: providing at least one top-view training image; aligning a training object present in the training image along a pre-set direction; labelling at least one training object from the at least one training image using a pre-defined labelling scheme; extracting at least one feature vector for describing the content of the at least one labelled training object and at least one feature vector for describing at least one background scene; and training a classifier model based on the extracted feature vectors.

### CROSS-REFERENCE TO RELATED APPLICATION

The present application is a national stage entry according to 35 U.S.C. § 371 of PCT application No.: PCT/EP2017/056933 filed on Mar. 23, 2017, which claims priority from German Patent Application Serial No.: 10 2016 206 817.2 which was filed Apr. 21, 2016 and is incorporated herein by reference in its entirety and for all purposes.

### TECHNICAL FIELD

The present description relates to the technical field of object recognition. The present description particularly relates to a training method for object recognition. The present description particularly relates to a detection method for object recognition. The description further relates to an object recognition method comprising the training method and the detection method. The description further relates to a surveillance system that performs the detection method.

The present description is particularly useful for object recognition in optic-distorted videos based on a machine training method. The description is further particularly useful for occupancy detection, in particular person detection, derived from top-view visible imagery as well as surveillance and presence monitoring.

### BACKGROUND

Vision based surveillance of a room or another predefined observation area is a basis for smart lighting concepts involving occupancy detection (which are aware of human presence and their activities) for realizing automatic lighting control. Vision based surveillance also gives provisions for advanced user light control on touch panels or mobile phones.

Occupancy detection and lighting control is mostly motivated by energy saving intentions, and the detection of stationary and persistent persons provides a key ability for realizing an autonomous and modern light control system.

Nowadays, light management systems mainly rely on passive infrared (short: PIR) based movement detectors which usually respond only to moving objects and therefore may not be sufficient for a modern occupancy detection system in the field of general lighting. In this regard, the development of a vision based camera sensor using adequate processing algorithms for video based presence recognition provides better means to detect the stationary and persistent presence in a room, i.e., without the necessity of any movement of the present person (s). Over the past three decades, computer vision and machine training have provided theory and algorithms for the detection of persons and other objects. With the development of the mass market for mobile camera systems and with the introduction of modern powerful processors as well as parallel computing systems, these concepts also became much more feasible in industrial applications which require a real time response. Concerning the application of computer vision in the field of general lighting, there exists the problem that due to the wide range of possible human appearances with changing poses and/or clothing in any background environment and lighting conditions, recognition of objects, in particular persons, is very difficult. This is specifically true if images are to be analyzed that are optically distorted, e.g. due to capturing the images with a distorted optics, e.g. a fish-eye camera. It is thus a problem that objects based on images captured with an optical distortion are rather difficult to recognize and may only be recognized with enormous computational effort. One method for object recognition (“Lowe's object recognition method”) is described in: David G. Lowe: “Object Recognition from Local Scale-Invariant Features”, Proceedings of the International Conference on Computer Vision, Corfu (September 1999), pp. 1-8. The Integral Channel Feature (ICF) algorithm is, e.g., described in: P. Viola and M. Jones, “Rapid object detection using a boosted cascade of simple features”, Computer Vision and Pattern Recognition, 2001, CVPR 2001, Proceedings of the 2001 IEEE Computer Society Conference, vol. 1, pp. 511-518; and by P. Dollar, Z. Tu, P. Perona, and S. Belongie, “Integral channel features”, BMVC, 2009.

The Aggregated Integral Channel Feature (ACF) algorithm has been introduced as a refinement and extension of the ICF algorithm in: by Piotr Dollar, Ron Appel, Serge Belongie, and Pietro Perona, “Fast Feature Pyramids for Object Detection”, IEEE Transactions on Pattern Analysis and Machine Intelligence archive, Vol. 36, no. 8, August 2014 pp. 1532-1545. The Histograms of oriented Gradients (HoG) method is, e.g., described in: N. Dalai and B. Triggs, “Histograms of oriented gradients for human detection”, Computer Vision and Pattern Recognition, 2005, CVPR 2005. IEEE Computer Society Conference on, vol. 1, no. 1, June 2005, pp. 886-893. The deformable part model (DPM) is e.g. described in: Pedro F. Felzenszwalb, Ross B. Girshick, David McAllester and Deva Ramanan, “Object Detection with Discriminatively Trained Part-Based Models”, IEEE Transactions on Pattern Analysis and Machine Intelligence, Vol. 32, no. 9, September 2010, pp. 1627-1645.

An application of a combination of HoG+linear support vector machines (SVM) schemes for the evaluation of omnidirectional fish-eye images is described in: A. -T. Chiang and Y. Wang, “Human detection in fish-eye images using HOG-based detectors over rotated windows”, ICME Workshops, 2014.

### SUMMARY

It is an object of the present description to at least partially overcome the problems associated with the prior art. It is an object of the present description to provide a training method and/or a detection method for object recognition that is more robust and more computationally efficient for recognizing objects.

The object may be achieved by the subject matter of the independent claims. Advantageous embodiments and embodiments are described, e.g., in the dependent claims and or the following description.

The object may be achieved by a training method for object recognition which comprises the following steps: In step a) at least one top-view training image is provided. In step b) a training object present in the training image is aligned along a pre-set direction. In step c) at least one training object from the at least one training image using a pre-defined labelling scheme is labelled. In step d) at least one feature vector for describing the content of the at least one labelled training object and at least one feature vector for describing at least one part of the background scene is extracted; and in step e) a classifier model is trained based on the extracted feature vectors.

This training method has the advantage that it provides a particularly robust and computationally efficient basis to recognize objects captured by a camera, in particular if the camera has distorting optics and/or has a camera distortion, e.g. being a fish-eye camera. Such cameras are particularly useful for surveilling rooms or other predefined observation area from above, e.g. to increase the area to be observed. The providing of the top-view training image in step a) may comprise capturing at least one image of a scene from a top-view/ceiling-mount perspective. The capturing may be performed by an omnidirectional camera, e.g. a fish-eye camera or a regular wide angle camera. Such a top-view training image may be highly distorted. For example, in an image captured by a fish-eye camera, the appearance of an object changes gradually from a strongly lateral view at the outer region of the image to a strongly top-down view, e.g. a head-and-shoulder view, in the inner region. Thus, a person is viewed strongly lateral at the outer region while a head- and-shoulder view is achieved in the inner region of the image.

The training object may be any object of interest, e.g. persons. What is regarded as an object of interest may depend on the intended application. For example, inanimate objects may not be used or regarded as objects of interest for one application (e.g. crowd surveillance) but may be objects of interest for another application (e.g. pieces of luggage for cargo distribution applications). A feature vector describing the content of a training object may be called a “positive” feature vector. A feature vector describing the content of a scene not comprising a training object (“background scene”) may be called a “negative” or “background” feature vector.

A training image may show one or more objects of interest, in particular persons. A training image may also show one or more background scenes.

At least one background feature vector may be extracted from a training image that also comprises at least one object. Additionally or alternatively, at least one background feature vector may be extracted from a top-view training image that comprises no training objects of interest but only shows a background scene (“background training image”). Thus, extracting at least one background feature vector may be performed by taking a dedicated background training image.

It is a non-limiting embodiment of step a) that the training image comprises pre-known objects. These objects may have been specifically pre-arranged to capture the training image. The objects may be living objects like persons, animals etc. and/or may be non-living objects like seats, tables, cupboards etc. It is a non-limiting embodiment that the training images captured in step a) are adjusted or corrected with respect to their brightness, contrast and/or saturation. This facilitates any of the following steps b) to d). This may also be called “normalization”.

In step b), the pre-set direction may be set without loss of generality and is then fixed for the training method. Thus, all objects considered for step b) may be aligned along the same direction. The aligning step/function might subsequently be referred to as remapping step/function.

It is a non-limiting embodiment that the aligning step b) comprises aligning the at least one object along a vertical direction. This e.g. allows imprinting rectangular bounding boxes in vertical object alignment. Vertical alignment is also preferred for use with a following detection method since if the sub-regions or “RoI samples” created by the detection method for examination are also be rotated to the vertical orientation.

In step b), one or more objects may be aligned from one training image, in particular sequentially.

In step c), one or more objects may be labelled from one training image. The labelling in particular means separating the (foreground) object from its background. This may also be seen as defining a “ground truth” of the training method. The labelling may be performed by hand. The labelling in step c) may also be called annotating or annotation.

Using the pre-defined labelling or annotation method of step c) comprises that the same general labelling process is used for different training objects. Advantageously, the predefined labelling method may be applied to different training objects in an unambiguous, consistent manner. The labelling method may comprise a set of pre-defined rules and/or settings to generate a bounding contour that comprises the selected training object. For example, one labelling method may comprise the rule to surround a selected training object by a vertically aligned rectangular bounding box so that the bounding box just touches the selected training object or leaves a pre-defined border or distance. The bounding box may have a pre-defined aspect ratio and/or size.

The content of the bounding box (or any other bounding contour) may be used as input for step d). A bounding box may also be used to label a negative or background scene and extract a background feature vector from this background scene. If the training image comprises at least one training object or object of interest, this may be achieved by placing one or more bounding boxes next to the object (s) of interest. The size and/or shape of the bounding boxes for a background scene may be chosen independently from the size and/or shape of the bounding boxes for labelling objects of interest, e.g. having a pre-defined size and/or shape. Alternatively, the size and/or shape of the bounding boxes for a background scene is chosen dependent from the size and/or shape of the bounding boxes for labelling objects of interest, e.g. being of the same size and/or shape.

Alternatively or additionally, a background feature vector may be extracted from the whole background or negative training image. In general, the steps b) and c) may be performed or executed in any order. For example, the labelling step c) may be preceded by the aligning step b), i.e. the object is aligned before it is labelled. Alternatively, the labelling step c) may precede the aligning step b), i.e. the object may be labelled and then aligned.

The classifier model is trained on the basis of the extracted feature vectors to be able to discern (to detect, to recognize) objects of interest also in unknown (test) images. Therefore, the trained classifier model may be used as a reference of performing the detection of the objects. The training of the classifier model provides its configuration that contains the key information of the training data (e.g. the feature vectors and their possible associations, as further described below). The trained classifier model may also be called a configured classifier model or a decision algorithm.

It is a non-limiting embodiment that the training method comprises a distortion correction step after step a) and before step d). This gives the advantage that the strong distortion associated with top-view images, in particular with omnidirectional images, may be mitigated or corrected. For example, a more reliable and unbiased judgement about the valid background region around a training object is enabled. This non-limiting embodiment is particularly advantageous for images captured by cameras comprising a fish-eye optic (“fish-eye camera”) which has a strong convex and non-rectilinear property. In this case, the appearance of a person changes gradually from the lateral view in an outer region of the image to a head-and-shoulder view in an inner region. The distortion correction (in this case radial distortion correction) may—at least partially—mitigate this effect to achieve a higher recognition rate.

Generally, the labelling step c) may be performed on the original, distorted training image, i.e. without distortion correction. For example, the labelling of a selected training object may be performed directly in a positive original training image from the (in particular fish-eye) top-view camera. In this case, after having placed the labelling contour or “bounding box” on the original training image, the thus labelled object and the attached bounding box are aligned to the pre-set direction, e.g. the vertical orientation. To facilitate drawing a correct labelling contour, auxiliary information such as dedicated landmarks of a person's body (e.g. a position of a person's neck, shoulders or beginning of the legs) may be used as a guidance to determine a real body's aspect ratio in the corresponding undistorted view.

After having placed the labelling contour under guidance of the body landmarks, the labelled/annotated training object and the respective labelling contour may be aligned to the vertical orientation, which may be the preferred alignment for extracting the features in step d).

It is a non-limiting embodiment that aligning step b) of the training method comprises unwrapping the training image, by performing a polar-coordinate transformation. Thus, aligning a training object comprises unwrapping this training object. In this case, the training image may be unwrapped to an (e.g. rectangular) image where the training objects of interest consistently show up in a vertical alignment. This gives the advantage that their orientations are directly suitable for the labelling/annotating step c). This is particularly useful for simultaneously aligning multiple objects of one training image. If the unwrapped image is a rectangular image, the result of the polar-coordinate transformation may be displayed again as an image in a rectangular coordinate system. Therefore, the original unwrapped image may be a rectangular image in Cartesian coordinates which is transformed to polar (phi; r)—coordinates which may then be displayed in a rectangular coordinate system again. Thus, the polar coordinate transformation finally ends up again in a Cartesian (rectangular) system for display.

In particular, a polar-coordinate image r=r(phi) or a log-polar image may be described by the following transformation with respect to a Cartesian coordinate system:

r=sqrt (x2+y2),

rlog=log (r) and

phi=arctan (y/x)

with x,y=(i−io), (j−jo) being Cartesian pixel coordinates with respect to an image center io,jo.

It is a non-limiting embodiment that the unwrapping process is preceded by the radial distortion correction. In another non-limiting embodiment, the radial distortion correction may be omitted or may follow the unwrapping process.

To improve quality of the unwrapped training image, known interpolation methods like nearest-neighbor or cubic splines (cubic interpolation) etc. may be applied. The unwrapping process may alternatively be regarded as a separate step following step a) and preceding step d). The radial distortion correction and the unwrapping may be performed in any desired order. It is a non-limiting embodiment that the aligning step b) of the training method comprises rotating the at least one training object. Thus, aligning a training object may comprise individually rotating this object. This embodiment provides a particularly easy aligning of single training objects. Also, the accuracy of the alignment may directly be fashioned. The rotation of single training objects may be performed alternatively to an unwrapping procedure.

The rotation process may alternatively be regarded as a separate step following step a) and preceding step d).

The radial distortion correction process and the rotating process may be performed in any desired order. It is a non-limiting embodiment that the labelled training object is resized to a standard window size. This embodiment enables extracting the feature vector (calculating the training object features) from a defined sub-section or sub-region of a predefined scale which in turn is used to improve object recognition. For example, if, in step d), feature vectors are extracted from “positive” objects of predefined size, an applying step iv) of a following detection method (i.e., the feature vectors being applied to the trained/learned classifier) advantageously becomes sensitive only to features of that predetermined scale.

The resizing may be performed by over-sampling or up-sampling to a certain standard window size. This window size may correspond to a size of a test window used in a detection method. The test window may correspond to the ROI sample or the sliding window.

The resizing of the labelled object may comprise resizing the bounding box of the labelled/annotated object. The resizing may be performed such that an aspect ratio is preserved. The resizing process may be part of step c) or may follow step c). The steps or processes after capturing the original training image and before the extracting step (i.e., adjusting brightness/contrast/saturation, resizing, aligning etc.) may be summarized as normalization steps or procedures. In a non-limiting embodiment, the labelled training objects are normalized before performing the extracting step d). This facilitates an unbiased training of the classifier model. In particular, the size and the brightness of the labelled training objects may be adjusted since these parameters may have an influence on the values of the corresponding feature vector. In a non-limiting embodiment, the extracting step d) of the training method comprises extracting the at least one feature vector according to an aggregate channel features (ACF) scheme (also called ACF framework or concept). This gives the advantage that the extracting step may be performed with a particularly high computational efficiency in a robust manner. This embodiment is particularly advantageous if applied to the aligned objects of a fish-eye training image. In general, however, other schemes or concepts may also be used for the extracting process.

The extracting of step d) may comprise or be followed by a grouping or assigning (categorizing) step that groups together one or more training objects and extracted “training” feature vectors, respectively, or assigns the extracting feature vector to a certain group.

The grouping or assigning (categorizing) may in particular comprise a connection between the at least one grouped feature vector and a related descriptor like “human”, “cat”, “table”, etc. To achieve this, several training images may be captured that each comprises the same object (e.g. persons). The resulting feature vectors of the same training object may be stored in a database and assigned the same descriptor. Of course, the database may also comprise feature vectors that are the only member of its group. A descriptor may or may not be assigned to such a singular feature vector.

The extracting of step d) may comprise or be followed by a grouping or assigning step that groups together one or more training objects and extracted “training” feature vectors, respectively, or assigns the extracting feature vector to a certain group. The grouping or assigning may in particular comprise a connection between the at least one grouped feature vector and a related descriptor like “human”, “cat”, “table”, etc. To achieve this, several training images may be captured that each comprises the same object (e.g. a certain person) in different positions and/or orientations. The resulting feature vectors of the same training object may be stored in a database and assigned the same descriptor. Of course, the set of feature vectors may comprise only one member of its group.

It is a non-limiting embodiment that the ACF scheme is a Grid ACF scheme. This allows a particularly high recognition rate or detection performance, especially for fish-eye training images.

In the Grid ACF scheme or concept, the training feature vectors of the labelled/annotated and vertical aligned objects are extracted and then grouped in various sectional categories (e.g. in seven groups or sub-groups) depending on their distance from the reference point of the training image, e.g. the center of a fish-eye image. For example, instead of grouping all feature vectors of a person obtained from multiple training images into one group (e.g. “human”), they are grouped in seven (sub-) groups (e.g. “human-1”, “human-2” etc.) that represent bands or rings of different distances from the reference point.

In the case of a fish-eye image, the different groups may correspond to positions of the object in different radial or ring-like sectors (the inner sector being disk-shaped). Thus, the feature vectors of a certain subgroup are only related or sensitive to this particular grid region or sector. Such a segmentation—in particular within the ACF framework—improves the distinctiveness and reliability of the employed classifier model. Each of the sectors may be used to train their own and dedicated grid classifier (e.g. by a per sector training of Grid ACF). Regarding the detection method, such a segmentation may be employed accordingly.

The grouping of the feature vector in different section categories may be facilitated by extending a dimension of the extracted feature vector for adding and inserting this group information as additional object feature (s). The extended feature vector is a compact object descriptor which in turn may be used for training a single classifier model covering again all the pre-defined region categories.

This embodiment makes use of the fact that in the top view perspective of a scene captured from an omnidirectional (e.g. fish-eye) camera, the appearance of a person changes gradually but significantly from the lateral view to the typical head-and-shoulder view in the inner region.

It is a non-limiting embodiment that the feature vectors of the labelled/annotated and vertical aligned persons are extracted and considered equally for all distances from the center of the image (“single ACF”). Consequently, the effective feature space declines and consequently a lag of distinctiveness and predictive power in a following detection method needs to be compensated by increasing the number of training images without reaching the limit of overfitting. Generally, the steps b) to d) may be performed repeatedly for one training image. Also, the training method may be performed for several training images. In particular, a set of positive and negative training images may be used from step a).

In a non-limiting embodiment, the classifier model is a decision tree model, in particular a

Random Forest model.

Alternatively, the classifier model may be a support vector machine (SVM), e.g. with an associated hyper plane as a separation plane etc.

The classifier model may comprise boosting, e.g. Adaboosting. The camera used for the testing method may be similar or identical to the camera used for the following detection method. The object is also achieved by a detection method for object recognition which comprises the following steps: In step i) at least one top-view test image is provided. In step ii) a test window is applied on the at least one test image. In step iii) at least one feature vector for describing the content of the test window is extracted. In step iv) the classifier model trained by the afore-mentioned training method is applied on the at least one feature vector. The providing step i) of the detection method may comprise capturing the at least one test image, preferably with the same kind of distorting optics, in particular omnidirectional (e.g. fish-eye) lens, that is used in step a) of the training method. The providing step i) may comprise capturing a series of images.

The applying step ii) may comprise that a pre-defined window (“test window”) which is smaller than the test image is laid over the test image, and the sub-region or “RoI (Region of Interest) sample” of the image surrounded by the test window is subsequently used for step iii) and step iv). The test window thus acts as a boundary or bounding contour, e.g. in analogy to the bounding contour of step c) of the training method.

Advantageously, the test window is applied several times at different position to one test image (“sliding window concept”) in order scan or to probe the whole test image. To achieve a high recognition rate, neighboring test windows and RoI samples, respectively, may overlap. The following steps iii) and iv) may be performed for each RoI sample.

It is a non-limiting embodiment that the form and size of the test window and RoI sample, respectively, correspond to the form and the size of the labelled training object(s) of the training part.

This facilitates the applying step iv) and improves the recognition rate. It is non-limiting embodiment that the test window scheme is a sliding test window scheme. In this scheme the test window slides or is moved progressively (preferably pixel-step-wise or “pixel-by-pixel”) over the test image in a line-by-line or row-by-row manner. Alternatively, the test window may slide in a rotational manner, e.g. around a reference point of the test images, e.g. a center of the image (“stepwise rotation”). For a further improved recognition rate, the test image and/or the RoI sample may be adjusted with respect to their brightness, contrast, saturation etc. (“normalization”). This may be performed in analogy to the training image, e.g. by using the same rules and parameters.

In step iii), the extracting of a feature vector may be performed similar to step c) of the training part, but now based on the RoI sample. It may suffice to extract a feature vector from one test window.

Applying the previously trained classifier model of step iv) on the at least one feature vector is equivalent to passing the extracted feature vector to the trained classifier model, e.g. for a class- or type analysis. As a result, the classifier model gives a “positive” result, i.e. that an object has been recognized, or a “negative” result, i.e. that no object has been recognized. In particular, the result of step iv) (i.e. the classification or comparison process) provides a similarity figure (probability) which may be compared with a pre-defined threshold value for being rated “true‘V’positive” or “false‘V’negative”. If a result “true” is reported, it may be assumed that a certain object has been identified within the test image. The classifying or classification process of step iv) may thus comprise determining a degree of similarity of the “test” feature vector of the RoI sample compared to at least one positive training feature vector and at least one negative training feature vector. The degree of similarity (e.g. represented by a score value) may be determined by using a support vector machine (SVM), a decision tree (e.g. Random Forest Classifier), etc. It is a non-limiting embodiment that the steps ii) to iv) of the detection method are repeated for different orientation angles of the test image provided in step i). This gives the advantage that test objects, which are not in alignment with the pre-defined direction (e.g. the vertical direction) for a given orientation angle of the test image, may be classified after rotating the test image. For fish-eye images, the orientation angle may be measured with respect to the center of the image (in general, from the center of the image as a reference point). This embodiment takes advantage of the fact that the test objects within the captured test image of step i) may show up in any azimuthal orientation angle. Thus, they typically would not be recognized when passed directly to the following steps iii) and iv) if the training feature vectors have been extracted for vertically oriented training objects only. To overcome this problem, the whole test image is rotated, and the test window scheme is repeated for each rotated test image.

It is a non-limiting embodiment that the test image is stepwise rotated by increments of typically 2 to 6 degrees, in particular 4 degrees. This gives a good compromise between a high computational efficiency and a good recognition rate.

Thus, the test window may be held on a fixed position and then the image may be rotated step-wise.

It is a non-limiting embodiment that the test window is successively applied to the whole test image for one particular orientation angle, e.g. using a sliding window scheme. For each of the resulting RoI samples the steps iii) and iv) are performed.

Subsequently, the test image is rotated by the pre-defined increment, and the test window is successively applied to the whole test image for this particular orientation angle. This procedure is repeated until the test image has made a full rotation/has been rotated 360°. Thus, the test window may be slid over the entire test image and then the image may be rotated step-wise.

It is also possible to align the test window contained in the test image in analogy to the training step by individual step-wise rotation or by the unwrapping via polar transformation of the entire test image.

It is a non-limiting embodiment that the test window has a fixed position and the test image is rotated by the pre-defined increment for a full rotation (360°). Then, the position of the test window is moved and the test image is again rotated by the pre-defined increment until a full rotation (360°) has been performed, and so on. For each of the resulting RoI samples the steps iii) and iv) are performed. This procedure is repeated until the test image has made a full rotation/has been rotated 360°.

The test window does not need to cover the full test image but its position may be varied along a radial direction with respect to the reference point, e.g. along a vertical direction.

One position of the test window may be a top position; another position of the test window may be position bordering the reference point. For example, the test window may be moved or slid step-wise only along a radial line but not over the entire image. Rather, to probe the entire image, it is stepwise rotated. Generally, neighboring test windows may be overlapping.

It is a non-limiting embodiment that RoI samples resulting from step ii) of the detection method are varied by resizing to different pre-selected sizes prior to step iii). This variation also contributes to an improved recognition rate. This embodiment makes use of the fact that, for the detection method, a distance of the camera to potential objects may be different, in particular larger, than for the training method. For example, a RoI sample may be enlarged and the regions “protruding” over the area bordered or bound by the test window may by disregarded or cut off. In general resizing or rescaling of the test image may be performed by resampling like up-sampling or down-sampling. This kind of resizing or rescaling may result in a set of RoI samples that show cutouts of the original RoI sample having the same absolute size but successively enlarged content with increased granularity. In analogy, the original RoI sample may also be reduced in size. The steps iii) and iv) may be performed for each member of this set of RoI samples, in particular including the original RoI sample. Therefore, by extracting and comparing the feature vectors from the RoI samples at different scales, the test objects of different sizes may be successfully detected, provided that the object is in the test window at all.

If a high number of resized/rescaled RoI samples have been created, the set of RoI samples establishes a finely scaled or “fine-grained” multiscale image pyramid (“multiscale approach”).

It is a non-limiting embodiment that RoI samples resulting from step ii) of the detection method are varied by resizing to different pre-selected sizes, feature vectors are extracted in step iii) from the varied RoI samples, and further feature vectors are calculated by extrapolation from these extracted feature vectors. This embodiment has the advantage that it needs only a smaller (“coarse”) set of varied (resized/rescaled and resampled) RoI samples and thus has a higher computational efficiency. Typically, only one varied RoI sample per octave of scale is needed. In order to fill the “gap” of feature vectors missing for unconsidered RoI sizes, these non-resized or non-scaled feature vectors are extrapolated in feature space based on the previously resized feature vectors by way of feature approximation. The extrapolation may therefore follow step iii). This embodiment may thus comprise rescaling of the features, not the image. It is another advantage of using extrapolated feature vectors that a feature vector extracted in step iii) from a RoI sample may not necessarily lead to a positive classification result in step iv) since the object size of the RoI sample on its scale may not match the size of the trained object. In contrast to that, an extrapolated version of this feature vector to a nearby scale might be a valid descriptor which reflects the real size of the object, and the classifier will therefore respond with a positive result. It is a non-limiting embodiment that the extracting step iii) of the detection method comprises extracting the at least one feature vector according to an ACF scheme, in particular a Grid ACF scheme. This gives the same advantages as using the ACF scheme, in particular a Grid ACF scheme, in the training method. In particular, this enables comparing test objects/feature vectors for same grid regions and sectors, respectively, as used for the training image. This, in turn, significantly enhances the recognition rate. For example, in step iv) only test feature vectors and training feature sectors belonging to same radial sectors of a fish-eye test image are compared.

Generally, after having found a positive match, a report may be issued. Such a report may, e.g., comprise the similarity score value of the detected object along with the radial section the object belongs to.

Generally, it is advantageous for achieving a reliable recognition rate that the conditions and processes of the training method and of the detection method are similar or identical. For example, in a non-limiting embodiment, the same or a similar type or kind of camera is used and/or that the same kind of extraction algorithm or process is used, etc. The object is also achieved by an object recognition method that comprises the training method as described above and the detection method as described above. Such a predefined method offers the same advantages as the above described training method and detection method and may be embodied accordingly. For example, the same kind of ACF scheme, in particular a Grid ACF scheme, may be used for both parts, i.e. the training part and the detection part.

Furthermore, the object is achieved by a surveillance system which comprises at least one vision-based camera sensor, wherein the system is adapted to perform the afore-mentioned detection method and embodiments thereof. Such a surveillance system provides the same advantages as the above described method and may be embodied accordingly.

For example, at least one camera sensor or camera may comprise an omnidirectional optics, e.g. a fish-eye lens or a regular wide-angle lens. The camera sensor or camera may be ceiling-mounted and in a top-view position, respectively.

The system may comprise data storage to store a training data base in which the training feature vectors extracted by the training method are stored. The system may comprise a data processing unit (e.g., a CPU, a GPU, a FPGA/ASIC-based computer unit, a microcontroller etc.) to perform the detection method based on a classification on the basis of the learned model from the training feature vectors.

The system may be adapted to issue a report/notice in case of a positive detection result to perform at least one action. Such an action may comprise giving out an alert, activating one or more light sources (in particular in relation to a position of the detected object in the surveilled or monitored area), opening or closing doors etc. The system may comprise or be connected to a lighting system. Vice versa, a lighting system may comprise or be connected to the surveillance system. The lighting system may activate and/or deactivate one or more lighting devices based upon a report/signal issued by the surveillance system.

The system may be integrated into a vision-based camera. Such a camera (and its camera sensor) is preferably sensitive to light in the visual range. The camera may alternatively or additionally be sensitive for infrared (IR) radiation, e.g. for near infrared (NIR) radiation.

It has to be noted that all elements, units and means described in the present application could be implemented in software or hardware elements or any kind of combination thereof. All steps which are performed by the various entities described in the present application as well as the functionalities described to be performed by the various entities are intended to mean that the respective entity is adapted to or configured to perform the respective steps and functionalities.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a flow diagram of an object recognition method comprising a training method and a detection method according to a first non-limiting embodiment;

FIG. 2 shows a captured top-view image with wide-angle optical distortion;

FIG. 3 shows an image with cells and contour-gradients;

FIG. 4 shows a flow diagram for a training method and a detection method according to a second non-limiting embodiment;

FIG. 5 shows another captured top-view image with wide-angle optical distortion;

FIGS. 6A-H show a set of captured top-view images with wide-angle optical distortion of the same surveillance region with a differently positioned object;

FIGS. 7A-C show a captured top-view image with wide angle optical distortion in different stage processing;

FIGS. 8A-B show another captured top-view image with wide-angle optical distortion in different stages of processing;

FIG. 9A-B show a captured top-view image with wide-angle optical distortion at different rotation angles; and

FIG. 10 shows a flow diagram for a training method and a detection method according to a third non-limiting embodiment.

### DETAILED DESCRIPTION

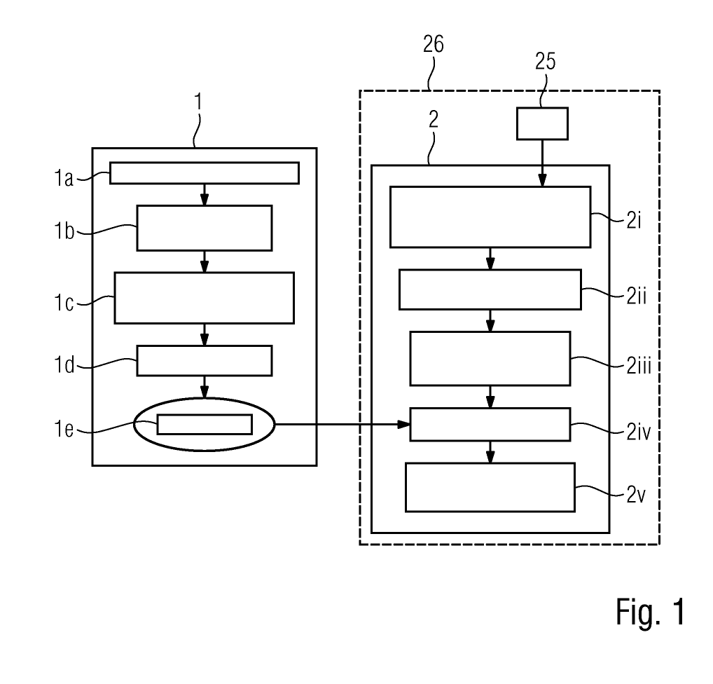

FIG. 1 shows a flow diagram of a training method 1 for object recognition and a detection method 2 for object recognition. The training method 1 and the detection method 2 may be combined to give an object recognition method 1, 2.

The training method 1 comprises a providing step 1a in which at least one top-view training image is captured, in particular by a ceiling-mounted fish-eye camera.

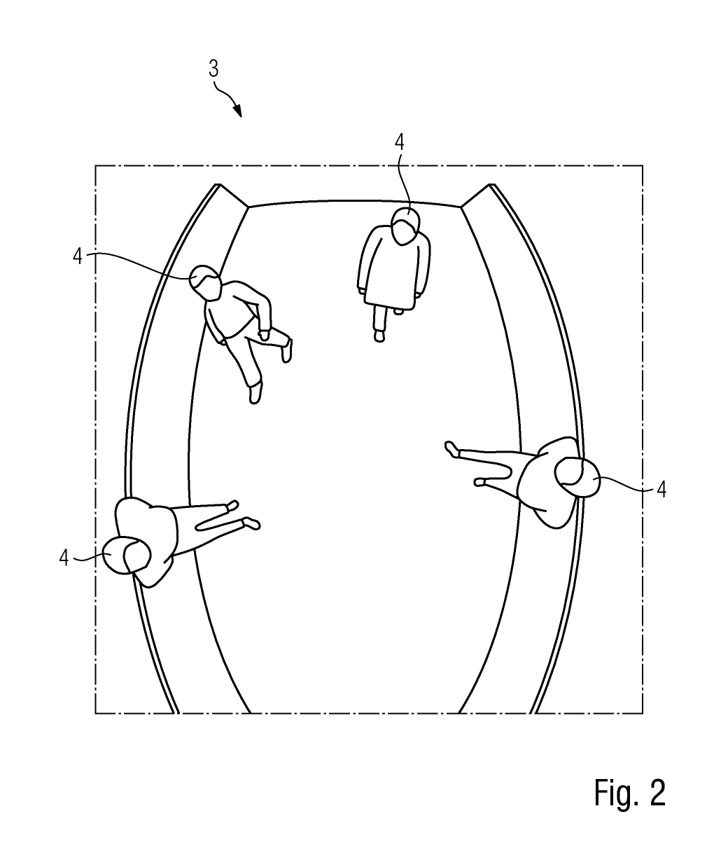

FIG. 2 shows a typical ceiling-mounted fish-eye image 3 which may be used as the training image. The shown fish-eye image 3 contains four objects of interest 4, i.e. persons, with different azimuthal orientation angles. All objects 4 appear in lateral view on a radial line (not shown) from a center. The image 3 may be used for the providing step 1a of the training method 1, in which case these objects 4 may be pre-known training objects. The image 3 may alternatively be used for a providing step 2i of the detection method 2 (as described further below), in which case the objects 4 are not typically known and have to be recognized.

The providing step 2i may be performed by a camera sensor 25 of a surveillance system 26. The camera sensor 25 may be part of a ceiling-mounted fish-eye camera. The surveillance system 26 may comprise more than one camera sensor 25. The surveillance system 26 may be connected to a lighting system (not shown) and may be adapted to report to a lighting system according to the result of the recognition of objects 4 in a field of view of the camera sensor 25. Thus, the surveillance system 26 operates using the detection method 2.

The training method 1 further comprises an aligning step 1b in which the at least one training object 4 is aligned.

In a following labelling step 1c, at least one training object 4 from the at least one training image 3 is labelled using a pre-defined labelling scheme.

In an extracting step 1d, at least one feature vector for describing the content of the at least one labelled training object 4 and at least one feature vector for describing at least one background scene is extracted.

Thus, a “positive” feature vector describing an object may be extracted, e.g. by employing steps 1c and 1d, steps 1b to 1d or steps 1a to 1d. In analogy to the “positive” feature vector extraction, a “negative” feature vector describing a background scene may be extracted e.g. by employing steps 1c and 1d, steps 1b to 1d or steps 1a to 1d.

In a training step 1e, a classifier model is trained based on the extracted (at least one positive and at least one negative) feature vectors. The classifier model might be fixed and scaled.

Thus, parameters of a classification algorithm (i.e., the classifier model), leveraging a predefined feature structure (i.e., a feature vector as a descriptor), are trained or learned from a set of labelled or annotated training images 4 and employed for the actual detection of objects in unknown new images (i.e., test images) taken during the detection method 2.

Regarding the detection method 2, it comprises a providing step 2i in which at least one top-view test image is provided, e.g. as shown in FIG. 2 with the objects 4 being test objects to be recognized.

In an applying step 2ii, a test window (not shown in FIG. 2) is applied to the at least one test image 3.

In an extracting step 2iii, at least one feature vector for describing a content of the test window is extracted. In an applying step 2iv, the classifier model—i.e. the same classifier model that was trained in step 1e of the previously described training method 1—is applied to the at least one test feature vector. In an optional step 2v, the result of the object recognition produced by applying the classifier model (e.g., an occurrence of a match, a class or group to which the recognized object belongs, a position of a recognized object and a score or match value etc.), is communicated (transmitted, reported) to an external entity, e.g. a lighting system.

Aspects of the training method 1 and the detection method 2 are now described in greater detail.

In the detection method 2, the same kind of feature vectors (i.e. feature vectors extracted by the same extraction method and/or of the same structure) may be used as in the training method 1.

The classifier model categorizes the test feature vectors either as belonging to objects of interest (positive match), such as persons, or as not belonging to objects of interest (negative match), such as background.

For larger scenes or for wide-field area surveillance, the location of the test objects may in particular be found using a sliding window technique in step 2ii in which a test window is shifted (“slid”) over the test image in order to surround and obtain an estimated location of the yet unknown test object.

The detection method 2 may further comprise a coarse-to-fine search strategy to find objects by generating an image pyramid of different scales on each of the sliding window positions for consecutive extracting/classifying steps.

By the use of appropriate feature vector concepts in conjunction with an appropriate classifier model (e.g. SVM or decision tree models), the required granularity for rescaling of the sliding window may be decreased and therefore the balance for computational demand may be decreased, too.

In the detection method 2, a captured test image of a surveillance area is scanned by a sliding test window of a predefined size (e.g. in step 2ii), and simultaneously the corresponding feature vector gets extracted (e.g., in step 2iii) in real time for being evaluated in the consecutive classification (e.g. in step 2iv).

Known types of classifier models are discriminative techniques or models such as support vector machine (SVM) and Decision Trees. Within the SVM framework, the SVM determines a decision boundary (hyperplane) in feature space or feature vector space is determined for separating between (true) positive pattern classes and (true) negative pattern classes. A decision tree directly maps the extracted feature vector to a binary realm of a true or false class by obeying rules from its trained configuration. Within a decision tree framework, multiple decision trees may be determined based on sample dimensions from the feature vector. Several classifier models might be applied in the context of object recognition as well as pedestrian recognition. In particular, a feature extraction using a Histogram of oriented Gradients (HoG) scheme may be combined with a classifier model comprising a linear support vector machine (SVM) and/or a decision tree model. These pairs (in particular SVM/decision tree) may be used in conjunction with the sliding window technique for larger images and coarse-to-fine scale matching.

The detection/recognition of objects of interest in a test image may comprise a classification of each window into one of two or more classes or groups, e.g. “person” or “background”.

In more detail, setting up a decision forest means determining, for each decision node, which feature vector dimensions to leverage and which threshold to use. This may hardly be determined by a manual inspection of an operator but requires an optimization procedure, also known as model training, e.g. according to step 1e.

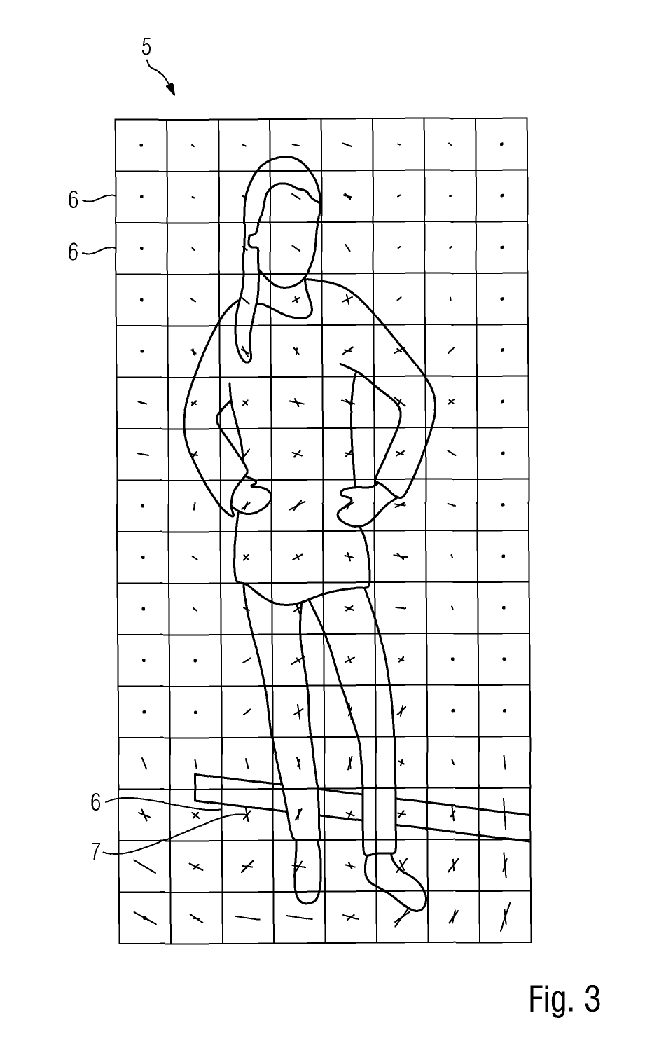

Regarding the histogram of gradients method, FIG. 3 shows a side-view image 5 which is subdivided into or covered by local image blocks or “cells” 6. Each cell 6 has a size of 8×8 pixels. The size of the cell 6 may be adjusted with respect to the size of the image 6.

For each cell 6, a gradient analysis is performed with extracts contours at certain predefined gradient orientations or direction angles. For example, nine gradient orientations from 0° to 160° in steps of 20° are considered. The determined contour-gradients 7 are grouped for each gradient orientation into a normalized histogram, i.e. in a normalized HoG. Specifically, the histogram may contain weighted gradient magnitudes at the corresponding quantized gradient orientations (bins).

For each cell 6, a respective HoG is determined. The HoGs are then combined for all cells 6 to form a feature vector of the image 5. Each bin of the HoG may be regarded as an entry or a “coordinate” of this feature vector. Alternatively, each value of contour-gradients 7 of each cell 6 may be regarded as the entries of the feature vector. The extraction of the feature vector may be achieved by sequentially moving the cell 6 over the image 5. A typical HoG based feature vector adds up several thousand entries containing the crucial information for ruling decisions whether an object of interest is present in the image 5 or not.

In the context of object recognition, the histogram of gradients HoG method is especially suitable for the representation and recognition of human patterns such as heads, shoulders, legs etc. In particular, the histogram of gradients method might also be applicable to top-view images.

Due to the normalization of the HoG-derived feature vector the HoG descriptor is highly contour-based and does not contain variations of the object due to illumination changes.

HoG features have been used for classification together with discriminative classifier models such as support vector machine (HoG+SVM). Regarding another aspect, test images capturing a larger field of view—in particular, surveillance images—may contain more than one object. In this case, the probing of the image may be carried out via a sliding test window scheme. That is, the captured test image is partitioned into numerous smaller, in particular slightly overlapping test windows, and for each test window, object recognition is performed, i.e., a feature vector is extracted and the classifier model is applied. If using a HoG scheme to extract a feature vector, each test window may be sub-divided into cells 6 as described above with respect to image 5.

In yet another aspect, HoG features are shift invariant, but not scale invariant. In order to cope with different observed object sizes, the classification may be repeated with different magnification levels of the input image (scale levels, zoom values), which is called the multi-scale approach.

Another method to extract a feature vector from an image comprises using Shift and scale invariant feature (SIFT) vectors. SIFT vectors are special descriptions of objects of interest which are generally valid and do not depend on or refer to the size of the object or to its actual position.

Thus, SIFT vectors are directly applicable for objects of any size.

Alternatively, appropriate feature extraction from visual data may be performed on different representation of the image such as Fourier-transformed images or Haar-transformed images.

In even another aspect, different sets of feature vectors may be used for increasing the reliability of the object recognition. To this effect, the technique of decomposing a structure (deformable part model, DPM) of an object into several subparts may be applied. This is based on the idea that most objects of interest are based on typical parts (e.g. wheels of cars, hands of people, etc.) and that there is a larger similarity among object parts rather than entire objects. Additionally, object parts generally are in specific constellation (hand attached to an arm attached to the body), which helps the detection. One possible constellation is the deformable part model (DPM), which is a star-shaped model whereby a central body, the “root”, is connected to limbs and smaller “parts”. For classification purposes, each of these models is evaluated separately and the individual responses are weighted for applying suitable competition rules between the multiple models for getting the final response as true or false. As the DPM algorithm is of higher complexity compared to the standard single HoG algorithm, the computational complexity for evaluating all predefined models is considerable higher both in the training method and the testing method. Furthermore, using the DPM model, real time detection is barely feasible. For real-world applications, rules for possible inter-object occlusion have to be incorporated into the model, too. The applicability of DPM is thus limited to images having a relatively high image resolution since each detector component requires a certain spatial support for robustness.

Regarding another possible extraction algorithm, Integral Channel Feature (ICF) algorithms and Aggregated Channel Feature (ACF) algorithms may be used as feature representations for efficient object recognition. These algorithms typically use shape-based features in combination with intensity variations prior to include also texture information in the classification process. ACF is a variant of ICF. In the ICF and ACF framework, different informative vision channels like a simple grayscale version or color channels like the three CIE-LUV channels or the HoG channels are extracted from a given image, which usually may be derived by the application of linear transformations:

C=W(I)

f=f(C)=f(W(I)

with C=linear transformation for extracting channels; and f=first-order channel feature for extracting features from the channels. In particular, ICF and ACF may extract: 1 (one) normalized gradient-magnitude (histogram based channel), 3 (three) colors, and 6 (six) HoGs to a total sum of ten channels. The HoG images are usually the most informative channels with highest detection performance and they are therefore often used as a base feature vector such as in the ACF framework.

In order to obtain a final discriminative feature description from the various image channels, the ICF-framework and the ACF-framework, however, pursue slightly different concepts. In the ICF framework, the structure for describing the object consists of special features, e.g. local sums of Haarlets, which may be computed very fast from an integral representation as an intermediate image representation of the registered channels. The typical features in the ICF-framework, which are derived from the integral image representation, are usually easy to calculate but often rather comprehensive.

In the ACF framework, the feature vector is derived from spatial integration of the channel images with a kernel of appropriate size and weight (“aggregation”), declining the size of the feature vector but preserving the key information concerning the prevailing pattern. In other words: ACF uses aggregated pixels from the extracted image channels by applying a small smoothing kernel and consequently using these pixel-based results as a features vector. Regarding the classifier model, a decision tree and boosted forest model in conjunction with the ACF framework will now be described in greater detail. One possible way to configure a tree based classifier model is to build up a deep and complex decision tree with many layers which may be directly mapped according to its values to the entire feature vector (s) and their respective class(es), e.g. whether a feature vector is a positive or a negative feature vector. The decision tree model is a deterministic classifier model where each node is related to a single feature vector dimension to make a decision about the decision trees' next branch, up to a tree leaf (terminal node), where a class decision (e.g. a positive or a negative match) is taken. This decision and its probability (score value) may then be reported. However, one drawback of a large and complex decision tree is its numerical instability such that a small change in the input data may lead to a dramatic change in the classification result, which usually makes decision trees poor classifiers.

To overcome this potential problem with a single and complex decision tree, a “boosted Random Forest” model may be used. In the framework of the “boosted Random Forest” model, a randomly set of weak and shallow decision trees are set up in parallel and trained sequentially for finally being cascaded and aggregated to a strong and reliable single classifier model.

In the ACF framework, each of the many feature vectors is used for building up a simple layered tree-stump which may be trained for having a prediction power of (slightly) more than 50 Percent. By taking a first trained classifier model, a set of known training images may be tested in order to obtain a new subset of training images whose content had been predicted wrongly by this first trained classifier model (or “sub-model”). A single trained classifier model is weak and provides plenty of false report. Then, the weak trained classifier model is trained further with the feature vectors of the second subset of training images which have failed by the first training. By repeating this scheme for all of the remaining feature vectors, a plethora of separately trained small decisions trees (i.e. forests) are readily prepared for being used in parallel and the final classifier model is performed mostly by casting a weighted majority vote. It is worth to mention that n decision trees with n weak votes are better and more reliable than one highly complex decision tree with one strong vote. The parallel operation of the random forest decision trees are advantageously computed using parallel computing. Generally, several combinations or pairs of extracting methods and classification models—e.g. HoG/SVM or ICF-ACF/boosted trees may be used. They are generally sufficient for qualifying and detecting objects of interest (e.g. humans like pedestrians and the like) in a surveillance scene. HoG features with linear SVM classification show good performance at images of higher resolutions. The ICF and ACF frameworks may particularly be used in conjunction with a boosted classifier model. In yet another aspect, the general difficulty arises that a chosen concept for extracting the feature vector or feature descriptor of a given object of interest is valid in general only for a certain appearance size of the object. Different appearance sizes of the envisioned object may require different feature vectors for getting properly classified or recognized. None of the above-mentioned feature vectors (bar for the SIFT scheme) are scale invariant and all of them would benefit from special rescaling techniques if they are used for classifying real world images with varying object sizes.

One approach to handle the scaling problem (if so wished) is to represent a captured image in many fine grained up-sampled or down-sampled scaling levels (“zoom in”, “zoom out”, “multi-resolution decomposition” etc.) in order to cast and represent the targeted objects in various sizes for extracting respective feature vectors and performing subsequent classifications. When an object of interest is eventually scaled to the right size, a classification with a fixed-scale classifier model will be able to reliably detect the object as a true positive. If no positive result was found for any of the represented scales or scaling values, the image is assumed to be devoid of objects of interest.

Applied to the HoG-based feature recognition, this concept is known as a “multiscale gradient histogram” and may comprise using an image pyramid stack of an object at different scales.

This approach demands higher computational effort, in particular because of the computation and extraction of the feature vectors at each scale of a given image.

Alternatively, to handle the challenge of varying object sizes, a special feature vector may be determined describing the object regardless of its size. This feature vector is a scale invariant description of the object. For example, SIFT feature vectors are invariant to uniform scaling, orientation, and partially invariant to affine distortion or illumination changes, see e.g. Lowe's object recognition method.

For example, the Viola Jones (V J) recognition scheme uses a shift and scale invariant feature vector or object descriptor. By having a scale invariant object description/feature vector, the consecutive classification step may be applied to a feature vector that has been extracted from an object without any rescaling or rotation. During classification, the computation and extraction of this feature vector needs to be done only once and may—due to its nature—immediately be fed to the classification model for true or false matching. Thus, the creation and application of a single SIFT vector, which is valid on any scale or pose or rotation or illumination condition of an object, enables a faster classification compared to the image multiscale approach. However, SIFT feature vectors may be limited in their applicability due to their complexity. To avoid defining a scale invariant feature vector and still gain computational efficiency, the concept of approximating feature vectors from one scale to a nearby scale is advantageously used. The method of approximating standard feature vectors comprises that the extraction of a standard feature vector of an object of a given scale also allows to calculate (approximate/estimate) corresponding feature vectors for nearby scales for being used in the classification process. The theoretical base for feature or feature vector approximation to multiple scales relies on the fact that the visual world shows some self-similarity over different scales which ensures that fractional power laws hold for preserving highly structured object features over scale changes (renormalization theory). In natural images, according to the so-called scaling hypothesis, the statistics around a certain image pixel are independent from the chosen scale and therefore the divergence of systematic features around a certain pixel is governed by a power law with fractional exponents. The rescaling of a given feature vector based on the numerical approximation is faster than the extraction process for differently scaled objects itself. In particular, the numerical re-estimation or approximation of feature vectors of a nearby scale from one or some few feature vectors derived from a given scale clearly outperforms the explicit extraction using feature vectors from pure multiscale images of finest grading.

However, feature approximation has its limits on far-off scales (typically starting from a factor 2 zoom-in or zoom-out), and thus, advantageously, a new appropriately resized image may be created to extract a new feature vector. The new feature vector may then be used for approximating intermediate members of a corresponding feature vector pyramid. For example, one new supporting vector may be used on any doubled scale step. In this context, a scale octave is the interval between one scale and another with a half or double of its value. In particular, the efficiency of approximating a feature vector in contrast to standard feature multi-scaling may be shown as follows: Starting from a given supported image I, the corresponding feature channel C and the corresponding feature vector v may be calculated as C=W(I) and v=f(c)=f(w(i)), where W is a linear transformation function for computing the feature channel of the image I and f is the feature vector extraction function for computing the feature vector from the feature channel image.

For gaining the feature vector vs of a rescaled image Is with Is=R (I, s), where R is a rescaling or resampling function with its scaling parameter s, the feature channel computation may be performed by the linear transformation C=W(I), respectively Cs=W (Is)=W (R (I, s)), and the final feature vector vs of the rescaled image may be gained by the feature vector extraction function f as vs=f(Cs)=f(W(Is))=f (W (R (I, s))).

In contrast to that, the concept of feature approximation by applying the scaling law implies that the feature vector vs may be calculated more efficiently as vs=v*s<(A)>=f (W(I))*s<<″A>>. This equation shows the simplicity for calculating the feature vector vs of a given image scale on base of feature approximation which is in contrast to calculating the feature vector vs according to the standard feature multi-scaling by rescaling the initial image with consecutive straightforward feature extractions.

Typical values for the fractional scaling exponent are λ¾0.0 for SIFTs; λ*0.1 for HoG and DPM; λ*0.195 for ICF; and λ*0.169 for ACF.

In particular, for approximating a feature vector of a nearby scale, the scaling law for visual information: f(Is)=f(I)*s<<″A>>may be applied. Then, evaluating f(R(W(I)s))=f(Is)=f(I)*s<<″A>>, I. e., performing a feature approximation, is faster than f(W(R(I,s)))=f(Is), i.e., a multiscale extraction, with Is=missing image of non-supported scale; C=visual image channel; W=C=W(I)=linear transformation for channel extraction; R=Is=R(I,s)=Resampling function; and f=v=f(I), feature vector function.

By this, a sound and fine-grained feature pyramid may be established which may later be used by a classifier model for detection purposes, meaning high fidelity approximations of multiscale feature vectors. The applicable fractional exponent λ for rescaling the feature vector depends on the inner structure of the feature vector and might be found from experimental results. This hybrid technique of coarse multiscale image representation in conjunction with feature approximation on nearby scales gives provision for much faster real time detectors in the field of computer vision.

The aforementioned extraction schemes like HoG, ICF, ACF have provisions for calculating approximated variants for nearby scales and therefore offer the possibility for combined multiscale image and feature pyramids for real time person detection. Hence modern surveillance detectors or systems may rely on multi scale methods to build up a feature vector pyramid for real-time classification of visible images.

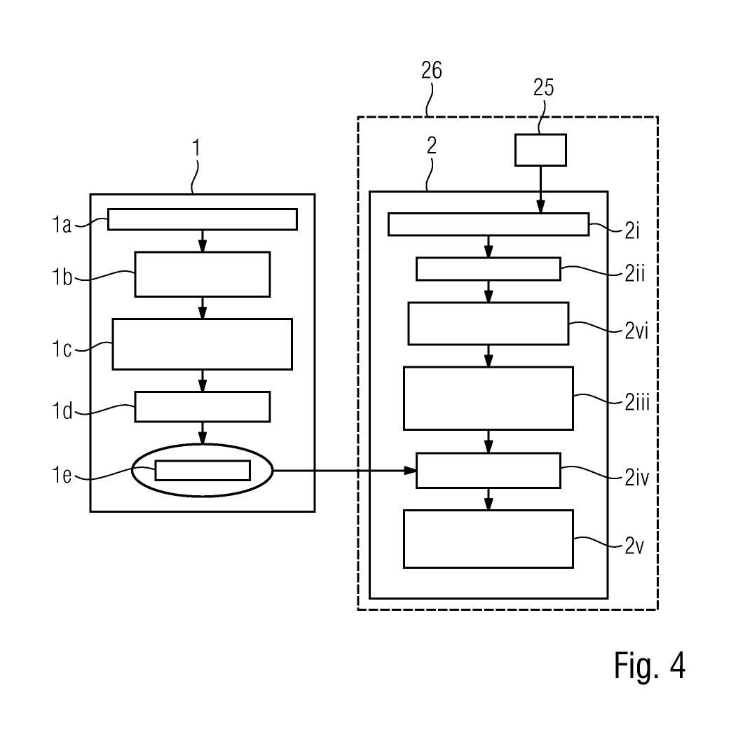

Thus, as shown in FIG. 4, the detection method 2 may thus have an additional step 2vi, wherein RoI samples resulting from step 2ii are varied by resizing to different pre-selected sizes prior to step 2iii (creation of image pyramids on the base of multi-scaling). This may also be formulated such that step 2iii is modified to include varying RoI samples resulting from step 2ii by resizing to different pre-selected sizes prior to extracting the respective feature vectors.

Additionally or alternatively, feature vectors are extracted in step 2iii from the varied RoI samples, and further feature vectors are calculated by extrapolation from these extracted feature vectors (creation of a feature pyramids on the base of feature scaling). This may be regarded as a modification of step 2iii as described in FIG. 1 or FIG. 4. In the following, imaging with top-view omnidirectional fish-eye lenses and object detection will be described in greater detail.

Omnidirectional camera systems, such as fish-eye based cameras, enable extremely wide angles observations with fields of view up to 180° and are thus preferably used in surveillance systems. Fish-eye based imaging is mainly performed from a ceiling-mount or top-view perspective that provides a wide view on a surveilled scene with low risk of occlusion. The optical mapping function of a fish-eye lens generates a typical convex and hemispherical appearance of the scene in which straight lines and rectangular shapes of the real scene usually show up as curved and non-rectilinear. Thus, images captured by a wide angle fish-eye based camera (as e.g. shown in FIG. 2) differ from the intuitive rectilinear pin-hole model and introduce undesirable effects, such as radial distortion, tangential distortion and uneven illumination levels, which may be summarized as “optical distortions”. The radial distortion of wide-angle and fish-eye lenses may cause severe problems both for human visual understanding as well as for image processing and applications such as object detection and classification.

The mapping function of a fish-eye lens describes the positioning of a sideways object in the scene by the relation between the incident ray angle Θ (theta) and its optical displacement in the focal plane as r=g(9, f) with r=optical displacement; g=mapping function; and f=focal length (intrinsic lens parameter).

The optical displacement r is measured from the center of distortion (CoD), which may be assumed practically to be the point at which the optical axis of the camera lens system intersects the image plane.

Upfront accurate estimation of the CoD is base for the correct application of software-based undistortion.

As the imaging of a standard rectilinear lens obeys the law of a pinhole model, i.e. r=f* tan(9) with Θ<90°, it represents an ideal and gnomic lens projection, which does not show radial distortion.

For an equidistant ideal fish-eye lens, the following mapping equation is applicable:

r=f*Θ

For an equal-area common fish-eye lens, the following mapping equation is applicable:

r=2*f*sin(9/2)

For an equal-of-angle stereographic fish-eye lens, the following mapping equation is applicable:

r=2*f*tan(9/2)

The stereographic fish-eye lens is particularly useful for low distorted non-extended objects as appearing in object detection. Thus, the stereographic fish-eye is advantageously used with the training method 1 and the detection method 2.

For an orthographic fish-eye lens which maintains planar illuminance the equation

r=f*sin(9)

is applicable.

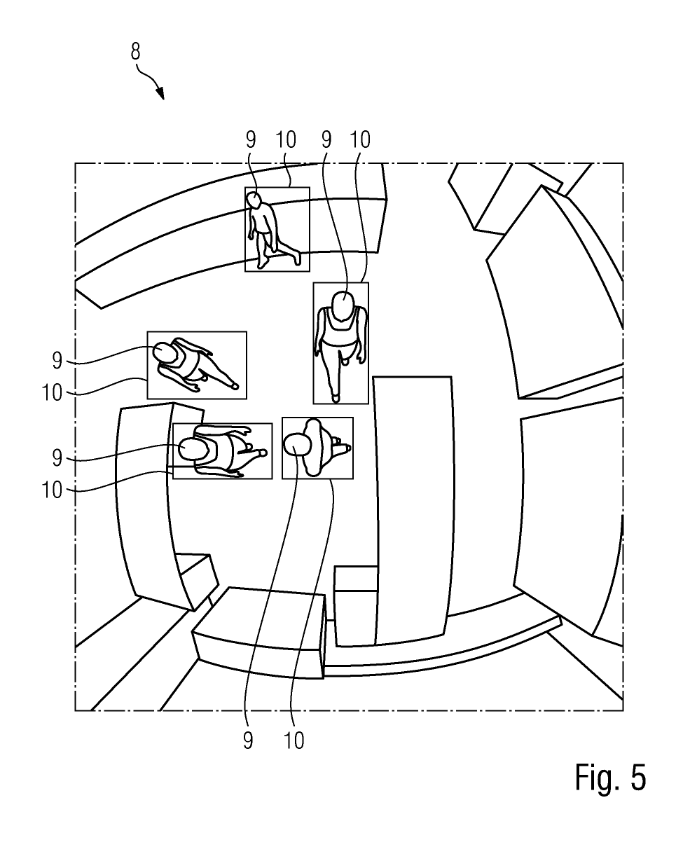

With the knowledge of the exact fish-eye calibration data like the CoD and imaging function, the optical lens distortion of the omnidirectional fish-eye camera may be corrected by aligning and reversing to an undistorted rectilinear projection, also referred to as “rectification”, “remapping”, “unwrapping” or “software-based undistortion”. The distortion correction may be part of, e.g., the aligning step 1b. Such a distortion correction or rectification of a fish-eye lens image by means of a post-lens compensation method is physically limited by the refractive characteristics of usual lens material and may practically be achieved only up to a 110° field of view (FoV) with reasonable cost. The distortion correction of fish-eye images may show an intrinsic lack of image resolution due to poor rendering behavior in far-off radial ranges from the center. Improvement of the remapping scheme may be achieved by applying interpolation methods like nearest-neighbor or cubic splines (cubic interpolation) etc. By application of an appropriate imaging software for aligning, the camera's intrinsic parameters may be acquired from a calibration, e.g. through checkerboard evaluations or taken from the known lens distortion model. Concerning the object detection with wide-angle fish-eye cameras, FIG. 5 shows another top-view image 8 with wide-angle optical distortion. Wide-angle optics allows a wide panoramic or hemispherical view of a surveillance area. Here, the image 8 has been captured by an omnidirectional fish-eye camera. Image 8 shows the same object 9, i.e. a walking person, at different positions or locations of the surveillance region, in particular at a distance from the center. The range of appearances for this object 9 in terms of orientation or height/width ratio (aspect-ratio)—as visualized by respective bounding boxes 10—is much larger than for a wall-mounted perspective. Near the center position of the camera and the image 8, resp., the object 9 appears to be higher and wider compared to a position at the outer region of the image 8.

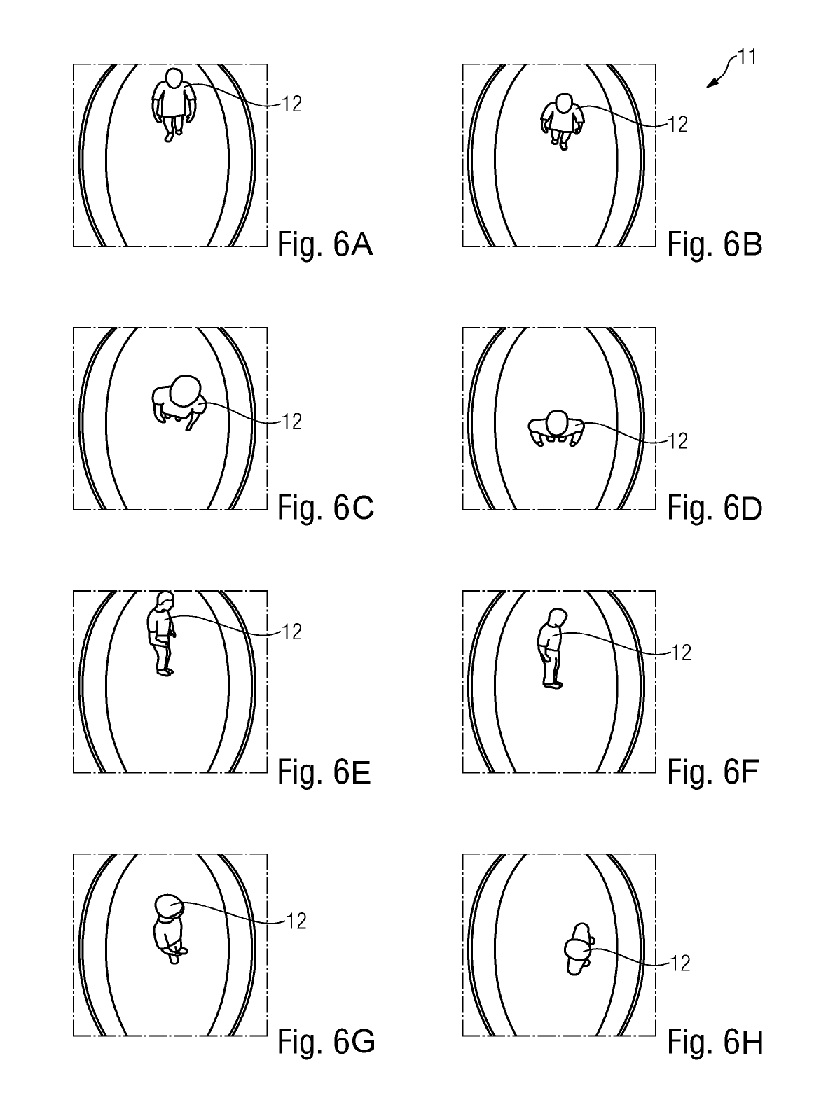

FIG. 6A to FIG. 6H show eight top-view images 11 of the same surveillance region with a differently positioned object 12, i.e., a person. FIGS. 6A to 6D show the object 12 being successively closer to the center of the respective top-view image 11 with the object 12 captured in a frontal view or frontally approaching. FIGS. 6E to 6H show the object 12 also being successively closer to the center of the respective top-view image 11 but with the object 12 captured in a side view or approaching sideways.

Concerning machine learned object detection, the top view perspective has the consequence, that the range of possible appearances of an object of interest increases considerably and the effective feature space, which is valid for describing all of the observed objects, declines.

Equivalently, due to the optical distortions in the images from fish-eye cameras, the feature vector has also to cover a higher degree of object variations, which finally weakens its specificity (distinctiveness) and in consequence impairs the predictive power of the classification process.

Thus, for camera observations with highly distorted imaging projection, the object detection phase or step is advantageously changed both regarding the training method and regarding the detection method.

Concerning the training method, an appropriate labelling step for objects of interest has been developed, namely step 1c using a pre-defined labelling scheme.

For facilitating an unbiased training of the classifier model, the labelled training objects are advantageously normalized before they are fed to the classifier model. In particular, a size and a position of labelled objects may be adjusted (resized) since these are the most important parameters with highest influence on the values of the feature vector. Additionally, the pre-annotated training images should ideally contain a high variety of possible object appearances in order to comprehensively cover most of the object-related feature space. However, in order to properly place the bounding box in omnidirectional fish-eye images, the strong distortion with its typical convex and non-rectilinear appearances leads to difficulties in aligning the to-be-labelled object uniformly in the bounding box. Possible advantageous labelling schemes—that overcome these difficulties—are now described in greater detail.

Firstly, a set of positive and negative training images may be acquired by capturing images from scenes having preferably complementary resemblance with and without presence of objects under various illumination intensity and background clutter. Secondly, the panoramic images may be remapped and corrected in order to obtain an undistorted view of the object for labelling (radial distortion correction). Rectification of the positive training images facilitates a more reliable and unbiased judgement about the valid background region around an object to be labelled.

Thirdly, the actual undistorted object of interest is rotated to a vertical line in order to enable the imprint of the rectangular bounding boxes in vertical object alignment with its appropriate aspect ratio. A vertical alignment for labelling is preferred, since in the later detection method, the sub-regions for examination (windows of interest, RoI) are preferably rotated to the preferred vertical orientation for extraction and classification.

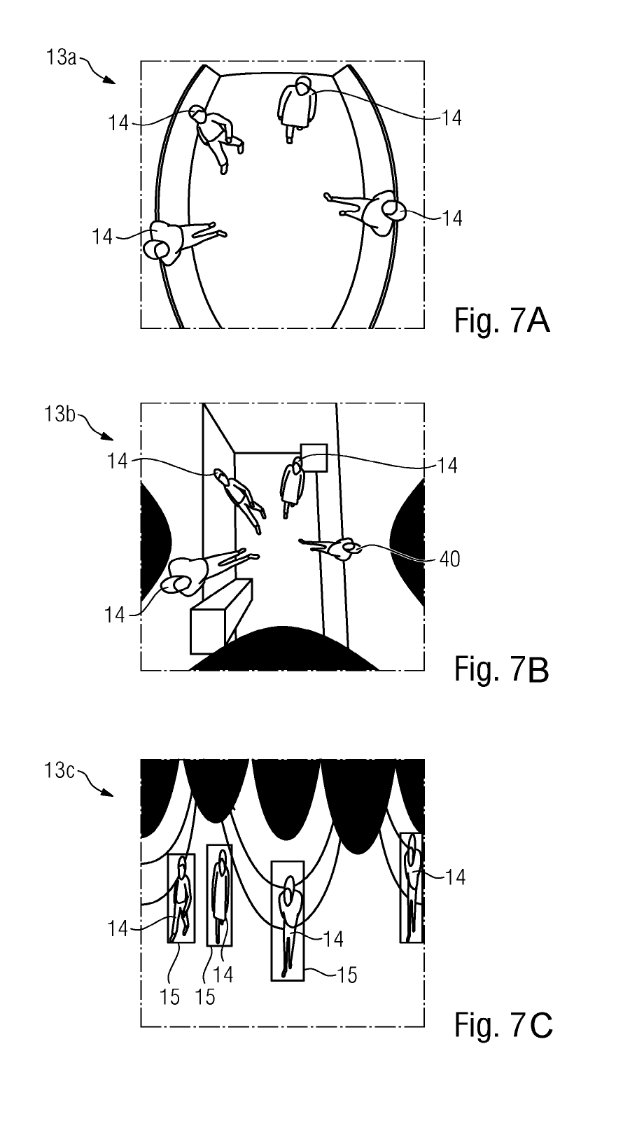

Alternatively, to the rotation of the objects of interest, the undistorted image may be unwrapped to a panoramic image in which the objects of interests consistently show up in vertical alignment and their orientations suit directly for the labelling: FIG. 7A shows an omnidirectional distorted fish-eye image 13a containing four different objects 14 in form of persons. In FIG. 7B, an image 13b is shown that is produced by camera calibration and software-based non-distortion of image 13a. In FIG. 7C, the camera-calibrated and software-based non-distorted image 13b of FIG. 7B has been transformed to an unfolded panoramic image 13c by Cartesian-to-Polar coordinate transformation. As a result of the distortion correction according to FIG. 7A to FIG. 7C, the targeted objects of interest 14 now show up consistently in vertical alignment and their orientations is suited directly for use with the labelling step 1c, as indicated by the bounding boxes 15.

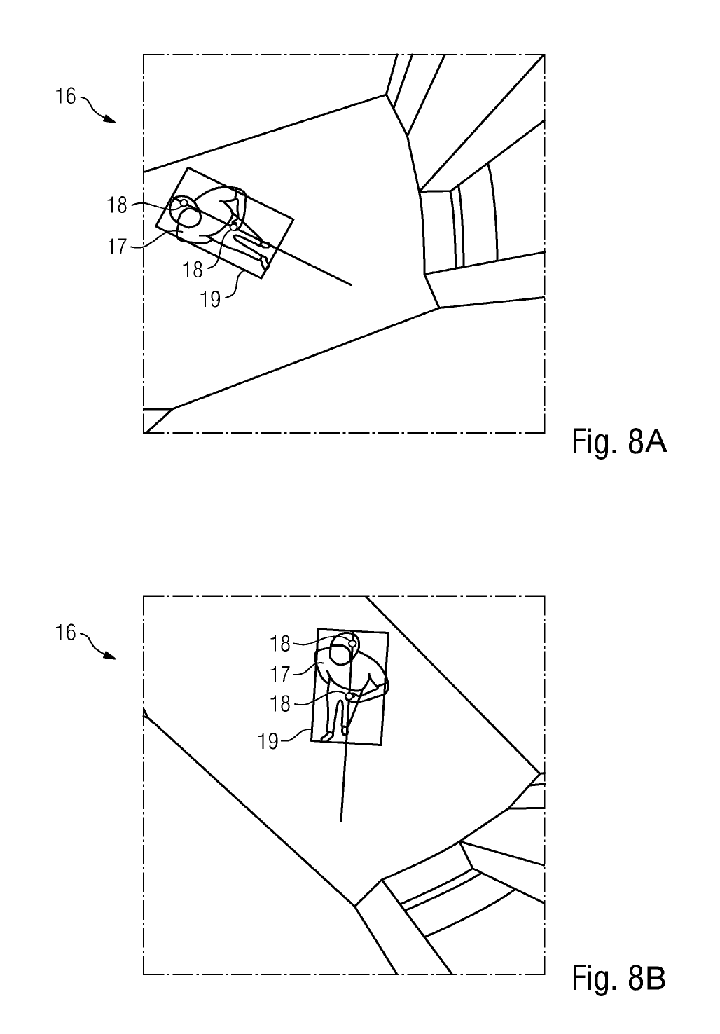

The polar-coordinate display r=r (phi) or a log-polar display may be achieved by the transformation equations r=sqrt (x<2>+y<2>) rlog=log (r) and φ=arctan (y/x) with x, y=(i−io), (j−jo)=Cartesian pixel coordinates with respect to an image center {io; jo}. In yet another alternative, the labelling of an object in an positive training images may be performed directly in the original image from the fish-eye camera, whereby auxiliary information such as dedicated landmarks on the object's body like a position of a neck, a position of shoulders or a beginning of legs are used as a guidance to determine the real body' s aspect ratio in the undistorted view, as is shown in FIGS. 8A and FIG. 8B: FIG. 8A shows, an original image 16 captured by a fish-eye camera containing an object 17, i.e., a person. By selecting typical body landmarks as guidance (shown as dots 18), the real aspect ratio of the object 17 and thus its bounding box 19 may be determined on the spot. It follows that the angle of the bounding box 19 with respect to a vertical direction is known.

In FIG. 8B, the image has been rotated such that the bounding box 19 is now aligned to a vertical direction or is vertically oriented. From these rotated selected objects, the feature vector is extracted to be fed to the classifier model for training purposes. After having placed the bounding box in the original fish-eye image under guidance of the body's landmarks, the labelled objects and the attached bounding boxes are rotated to the vertical orientation, which is the preferred alignment for extracting the features in step 1d for feeding the classifier model in step 1e.

To improve the quality of the described remapping procedures like rotation or coordinate transformation, interpolation methods may be applied like nearest-neighbor or cubic splines (cubic interpolation) etc.

Fourthly, the bounding box of the annotated or labelled object may be resized either by over- or up-sampling to the size of the bounding box for calculating the object features in a defined image section of a defined scale.

For enabling a particularly efficient object recognition, it is advantageous to choose a robust feature structure for describing the object that also enables a fast classification. The ACF extraction framework has been found to be particularly advantageous for analyzing omnidirectional fisheye images. Fifthly, the classifier model (e.g. a SVM model or a decision-tree, e.g. random forest, model) may be configured (trained) according to the extracted results in the feature vectors from a labelled set of “positive” images with a presence of at least one object of interest and a set of “negative” images without such an object of interest.

In particular, without further adaptations, positive feature vectors may be extracted from rescaled objects of predefined size with the consequence that the learning-based classifier finally becomes sensitive only to features of that scale or size.

Since in the top-view perspective of a scene captured from a fish-eye camera the appearance of a person gradually changes from the lateral view to the typical head-and-shoulder view in the inner region (see e.g. FIGS. 6A to 6H above), the model training of the classifier is advantageously performed accordingly: In one variant the feature vectors of the labelled and vertical aligned objects of interest are extracted and considered equally for all distances from the center, which means that the true feature space declines and consequently the lag of distinctiveness and precision of the classifier may be compensated by increasing the number of training images without reaching the limit of overfitting.

In another variant, the feature vectors of the labelled and vertical aligned objects are extracted and grouped in various categories, e.g. seven groups in a Grid ACF, depending on their distances from the center. The feature vectors of each of the various radius categories are collected for training a specific classifier model (e.g. a boosted forest tree), which becomes sensitive only to this particular radial distance.

The corresponding extracting step in the detection method may be structured equivalently. When performing or running the detection method, images captured by a top-view fish-eye camera may also contain objects (test objects) that may show up in any azimuthal orientation angle. Particularly if the classifier model is trained for vertical orientations only, the test objects cannot be passed directly to the classifier without a degradation of efficiency. To avoid such degradation and loss of efficiency, the test image is stepwise rotated until the various objects will finally show up in the vertical aligned (top) position where a rectangular test window is stationarily placed for subsequent application of the detection method with feature extraction and consecutive classification.

In order to achieve this, firstly, the test images of the scene to be tested for object presence are captured by an omnidirectional camera.

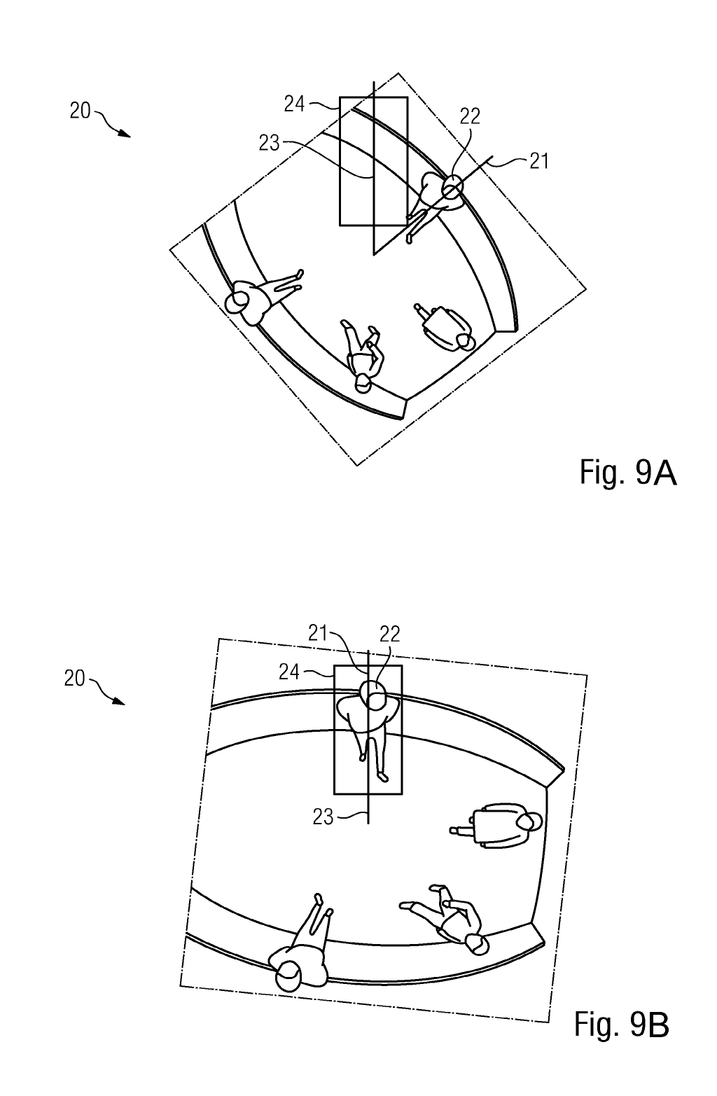

Secondly, the captured test image may be stepwise rotated to any orientation by increments, e.g. by four degrees. This may be part of step 2ii. For each rotation step, the extraction step and the classification step may be performed on the content of the vertical test window which is now described with respect to FIG. 9A and FIG. 9B:

In FIG. 9A, an original test image 20 is shown in which a slanted line 21 represents a radial line originating from the image center and intersecting with an object 22. A vertical line 23 also originating from the image center represents a reference line for a rotation. The vertical line 23 is a symmetry line for a stationary region of interest surrounded by a test window 24. The test window 24 is vertically aligned. The captured test image 20 is stepwise rotated around the image center to any orientation by certain increments, e.g. by four degrees. By repeatedly stepwise incrementing of the angle and image rotation, the targeted object 22 finally reaches the vertical alignment being thus contained in the test window 24, as seen in FIG. 9B. Line 21 coincides with the vertical line 23. The object 22 may be robustly and efficiently detected.

Thirdly, a comprehensive set of rescaled ROI samples of different scales are selected and resized to the standard test window size (which might be consistent with the window size of the training method 1) in order to establish a fine-grained multiscale image pyramid, also referred to as a multi-scale approach. Feature vector extraction is performed on each of the image pyramids for the provision of classification on different scales.

Thus, by extracting the features from the ROIs at different fine-grained scales, the objects of different fine-grained sizes may be successfully detected, provided that the object is in the test window at all.

Alternatively or additionally, a coarse set of different RoI samples of different sizes scales is selected and the RoI samples may each be resized to the standard window size, which might be consistent to the training method, in order to establish coarse-grained multiscale image pyramids, for instance with one sample per octave of scale.

In order to fill the gap of the missing feature vectors from the unconsidered RoI sizes, these non-extracted features are computed and extrapolated on support from the previously extracted coarse-grained feature vectors by the laws of feature approximation.

For classification, the entire feature vectors, including the approximated features, have to be passed to the classifier model to assure comprehensive testing on different scales. A supporting feature vector from a measured RoI may not necessarily lead to a positive detection result as the measured object size on this scale may not match the size and/or the scale of the trained object.

However, in contrast, the extrapolated version of this feature vector to a nearby scale might be a valid descriptor, which reflects the real size of the object, and the classifier model will therefore respond with a positive result.

Fourthly, the extracted feature vectors are classified by the trained classifier model either as a true positive (object is present) or a true negative (no object in the image).

Fifthly, a score value/matching degree from the applied classification is reported to an external unit.

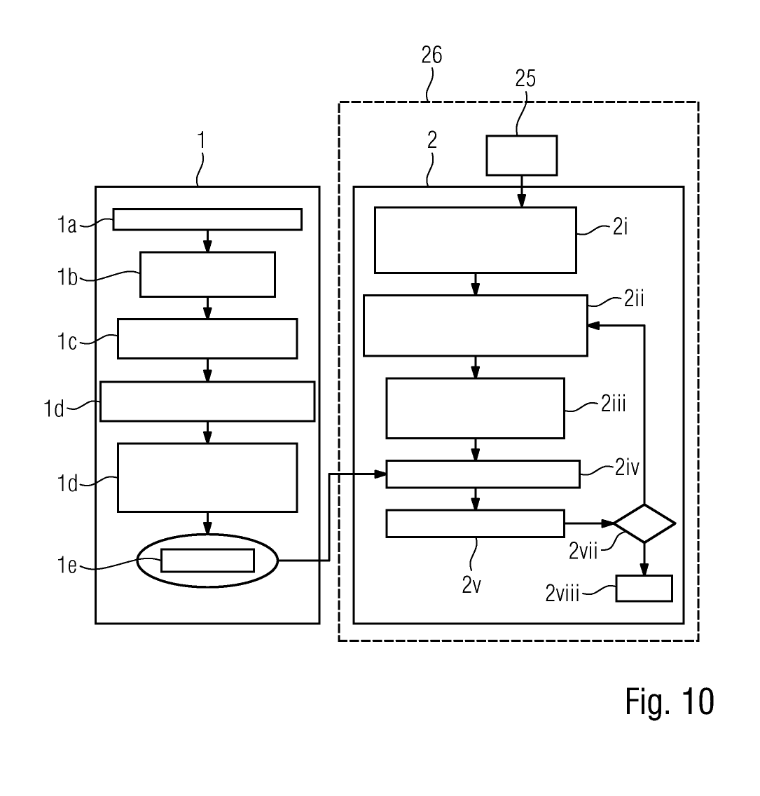

Sixthly, a loop starting with applying the test window (e.g. in step 2ii) by rotating the test image may be repeated until the entire test image has been stepped through a full rotation of 360° and all parts of the test image have been passed through the vertical aligned detection window. FIG. 10 shows a flow diagram for a training method 1 and a detection method 2 wherein—as compared to FIG. 1—the detection method 2 is modified such that the steps 2ii to 2v are repeated for each rotation step, as represented by rotation step 2vii. This ends, as indicated by step 2viii, only if the image has been rotated by 360°. In particular, in the training method 1, unbiased annotation or labelling may be included in step 1b by representing the object of interest in an undistorted and vertical aligned view, as could be achieved by rectification, rotation and/or unwrapping.

In the detection part, the RoI scenes are brought to a vertical pose lying within a predefined test window by stepwise rotation of the entire image. While various embodiments of the present description have been described above, it should be understood that they have been presented by way of example only, and not limitation.

Numerous changes to the embodiments may be made in accordance with the disclosure herein without departing from the scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more embodiments, equivalent alterations and modifications will occur to others skilled in the art upon the reading and understanding of this specification and the annexed drawings. In addition, while a particular feature of the invention may have been disclosed with respect to only one of several embodiments, such feature may be combined with one or more other features of the other embodiments as may be desired and advantageous for any given or particular application. For example, the resizing step 2vi may be combined with the rotation step 2vii and the end step 2viii.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

### LIST OF REFERENCE SIGNS

Training method 1

Providing training-image step 1a

Aligning step 1b

Labelling step 1c

Extracting step 1d

Training step 1e

Detection method 2

Providing test-image step 2i

Applying test window step 2ii

Extracting step 2iii

Applying classifier model step 2iv

Outputting step 2v

Resizing step 2vi

Rotation step 2vii

End step 2viii

Top-view image 3

Object 4

Side-view image 5

Cell 6

Contour-gradient 7

Top-view image 8

Object 9

Bounding box

Top-view image 11

Object 12

Image 13a

Undistorted image 13b

Panoramic image 13c

Object 14

Bounding box 15

Image 16

Object 17

Body landmark 18

Bounding box 19

Test image 20

Body line 21

Object 22

Vertical line 23

Test window 24

Camera sensor 25

Surveillance system

1. A training method for object recognition, the training method comprising:
providing at least one top-view training image;
aligning at least one training object present in the training image along a pre-set direction;
labelling at least one training object from the at least one training image using a pre-defined labelling scheme;
extracting at least one feature vector for describing the content of the at least one labelled training object and at least one feature vector for describing at least one background scene; and
training a classifier model based on the extracted feature vectors.

2. The training method according to claim 1 comprising a distortion correction step after providing the at least one top-view training image and before labelling the at least one training object from the at least one training image.

3. The training method according to claim 1, wherein aligning the training object present in the training image along the pre-set direction comprises unwrapping the training image.

4. The training method according to claim 1, wherein aligning the training object present in the training image along the pre-set direction comprises rotating the at least one training object.

5. The training method according to claim 1, wherein the labelled training object is resized to a standard window size.

6. The training method according to claim 1, wherein extracting the at least one feature vector for describing the content of the at least one labelled training object and the at least one feature vector for describing the at least one background scene comprises extracting the at least one feature vector according to an Aggregated Channel Feature (ACF) scheme.

7. The training method according to claim 6, wherein the ACF scheme is a Grid ACF scheme.

8. The training method according to claim 1, wherein the classifier model is a decision tree model.

9. A detection method for object recognition, the detection method comprising:
providing at least one top-view test image;
applying a test window on the at least one test image;
extracting at least one feature vector for describing the content of the test window;
applying the classifier model trained by a training method for object recognition on the at least one feature vector comprising:
providing the at least one top-view training image;
aligning at least one training object present in the training image along a pre-set direction;
labelling the at least one training object from the at least one training image using a pre-defined labelling scheme;
extracting the at least one feature vector for describing the content of the at least one labelled training object and the at least one feature vector for describing at least one background scene; and
training the classifier model based on the extracted feature vectors.

10. The detection method according to claim 9, wherein applying the test window on the at least one test image;
extracting the at least one feature vector for describing the content of the test window; and
applying the classifier model trained by the training method for object recognition are repeated for different orientation angles of the test image provided in providing the at least one top-view test image.

11. The detection method according to claim 9, wherein RoI samples resulting from applying a test window on the at least one test image are varied by resizing to different pre-selected sizes prior to extracting at least one feature vector for describing the content of the test window.

12. The detection method according to claim 9, wherein RoI samples resulting from applying the test window on the at least one test image are varied by resizing to different pre-selected sizes, feature vectors are extracted by extracting the at least one feature vector for describing the content of the test window from the varied RoI samples, and further feature vectors are calculated by extrapolation from these extracted feature vectors.

13. The detection method according to claim 9, wherein extracting the at least one feature vector for describing the content of the test window comprises extracting the at least one feature vector according to an Aggregated Channel Feature (ACF) scheme.

14. An object recognition method comprising the training method according to any of the claim 1 and the detection method according to claim 9.

15. A surveillance system comprising at least one vision-based camera sensor, wherein the surveillance system is adapted to perform the detection method according to claim 9.
